(19) United States
(12) Patent Application Publication
(10) Pub. No.: US 2020/0292031 A1
(43) Pub. Date: Sep. 17, 2020

(54) Power transmission device

(71) Applicant: Kuo-Cheng Wu, Taoyuan City (TW)

(72) Inventor: Kuo-Cheng Wu, Taoyuan City (TW)

(21) Appl. No.: 16/795,912

(22) Filed: Feb. 20, 2020

(30) Foreign Application Priority Data
Mar. 14, 2019 (TW) 108203044
Nov. 25, 2019 (TW) 108215615

(51) Int. Cl. F16H 1/20; F16H 57/02

(52) U.S. Cl. CPC F16H 1/20; F16H 2057/02034; F16H 57/02

(57) ABSTRACT

A power transmission device includes a box, a first platform, a second platform, a rotating shaft, a first gear, a second gear, a motor, and an energy output end. The motor is provided on the first platform and includes a third gear. The third gear meshes directly with the first gear such that when the motor drives the third gear into rotation, the first gear is driven into rotation by the third gear and in turn drives the rotating shaft and the second gear into rotation. The energy output end functions as a stop, has a gear structure for meshing with the second gear, and is configured to convert the energy generated by the rotation of the second gear and store the converted energy.

### BACKGROUND OF THE INVENTION

### 1. Technical Field

The present invention relates to a power transmission device and more particularly to a power transmission device that can maintain its moment of inertia and output energy stably once in operation.

### 2. Description of Related Art

The law of the lever has long been applied in our daily lives to save the time and effort required for operating an implement. Some notable ancient examples of lever-assisted activities are, among others, drawing water from a well and removing a big rock. Recently, with the rapid development of motor vehicles, the law of the lever has been applied to the drivetrains of such vehicles, preferably in conjunction with gear trains, gearboxes, or gears of different sizes in order to change the speed and torque of motor output.

While applications of the law of the lever and gear-related applications abound in the modem society, implements that work on the very law or gears and are targeted at the general public can hardly find application in heavy industry or power plants because they are often small to meet consumers' demand for user-friendliness, whereas implements designed to cater for heavy industry or power plants (e.g., steel bar carriers used in the steel industry) are generally much larger.

To increase the work efficiency or throughput of heavy industry or the power generation industry, those who work in the aforesaid industries are usually required to develop suitable implements on their own. Now that implements for use in those industries are in most cases of considerable size, it is imperative to design a device that can be applied to a heavy-industry or power generation implement, provide a sufficient amount of power for the implement, convert the power into another form of energy (e.g., electric power), and deliver the energy to the implement to enable efficient operation thereof.

### BRIEF SUMMARY OF THE INVENTION

In light of the above, it is an objective of the present invention to provide a power transmission device that can be applied to a large machine tool in heavy industry or to a power generation apparatus. The power transmission device of the invention can incessantly output the energy it generates, the working principles involved including inertia, the law of the lever, and a reduction in speed followed by an increase in speed. One advantage of the invention, therefore, is sustained output of energy. Moreover, as the major gears used in the invention have larger diameters than the gear trains used in motor vehicles, the power transmission device of the invention can generate more energy (e.g., larger torques) than those gear trains, and the generation of such relatively large torques is another advantage of the invention.

Another objective of the present invention is to provide a power transmission device capable of torque amplification. The power transmission device of the invention uses a relatively large gear to drive a relatively small gear, so the torque of the relatively small gear increases with the torque of the relatively large gear, which renders the power transmission device suitable for use with a machine whose operation requires a large torque. The power transmission device of the invention is also applicable to power supply systems because the energy provided by the power transmission device can be further converted into electric energy. Moreover, in order for the power transmission device to supply and output energy continuously, the law of inertia is applied in the invention by rotating the relatively large gear with a motor so that the relatively large, and hence relatively heavy, gear will keep rotating and thus driving the other gears into rotation for energy generation. The energy thus generated will be collected by an energy output end device disposed alongside the last gear, in order for the energy output end device to convert the energy (e.g., into electric or thermal energy) for further use or storage.

According to the first aspect of the present invention, a power transmission device includes a box, a first platform, a second platform, a rotating shaft, a first gear, a second gear, a motor, and an energy output end. The box has a bottom panel, a first outer panel, a second outer panel, a left panel, a right panel, a first inner panel, and a second inner panel. The first outer panel, the second outer panel, the left panel, the right panel, the first inner panel, and the second inner panel are provided on the bottom panel. The bottom panel, the first inner panel, the second inner panel, the left panel, and the right panel form a first chamber. The top end of the first inner panel is provided with a first engaging groove, and the top end of the second inner panel is provided with a second engaging groove. The first platform is connected to the top edges of the first outer panel, of the left panel, and of the first inner panel. The second platform is connected to the top edges of the second outer panel, of the right panel, and of the second inner panel. The rotating shaft has two ends mounted respectively with a first bearing and a second bearing. The first bearing and the second bearing are fitted in the first engaging groove and the second engaging groove respectively. The first gear is mounted around the rotating shaft, and so is the second gear. The first gear and the second gear are located between the first bearing and the second bearing such that when the rotating shaft is placed in the first engaging groove and the second engaging groove via the first bearing and the second bearing respectively, a lower portion of the first gear and a lower portion the second gear are in the first chamber. The motor is provided on the first platform and includes a third gear. The third gear meshes directly with the first gear such that when the third gear is driven to rotate by the motor, the first gear is rotated as well and in turn rotates the rotating shaft and the second gear. The energy output end is provided on the second platform, has a gear structure for meshing with the second gear, and is configured to convert the energy generated by the rotation of the second gear and store the converted energy. In one embodiment, the energy output end further has a stop structure for contact with the second gear. In one embodiment, the rotating shaft, the first gear, the second gear, the first bearing, and the second bearing constitute a primary gear train. In some embodiments, the first platform is connected to the first outer panel and the first inner panel while the second platform is connected to the second outer panel and the second inner panel. In some embodiments, there may be one or more than one motor.

According to the second aspect of the present invention, a power transmission device includes at least one motor and a plurality of gear trains in order to output more energy. In one embodiment, a first rotating shaft, a first gear, a second gear, a first bearing, and a second bearing constitute a primary gear train, and a plurality of secondary gear trains are provided to increase the energy input into and output from the primary gear train. Each secondary gear train includes a second rotating shaft, a fourth gear, a fifth gear, a third bearing, and a fourth bearing, wherein the third bearing and the fourth bearing are mounted around the two ends of the second rotating shaft respectively and are fitted in a first engaging grove and a second engaging groove respectively, wherein the fourth gear and the fifth gear are mounted around the second rotating shaft and are located between the third bearing and the fourth bearing, and wherein a lower portion of the fourth gear and a lower portion of the fifth gear are located in the first chamber. In some embodiments, each fourth gear has a larger diameter than the corresponding fifth gear. In order to mount the multiple gear trains, the top end of the first inner panel of the box of the power transmission device is provided with a plurality of first engaging grooves, and the top end of the second inner panel of the box is provided with a plurality of second engaging grooves. In one embodiment, when a plurality of motors drive their respective third gears into rotation, the fourth gears are driven into rotation as well and in turn rotate the second rotating shafts and the fifth gears in the secondary gear trains respectively; as a result, the first gear in the primary gear train is rotated by the fifth gears and in turn rotates the first rotating shaft and the second gear in the primary gear train.

To draw more energy out of the foregoing power transmission device, the power transmission device is provided with at least one energy output end. The at least one energy output end functions as a stop, has a stop structure for contact with the periphery of the second gear (which periphery may be viewed as the periphery of the first rotating shaft) in order to draw energy from the second gear, and is configured to convert the energy generated by the rotation of the second gear and of the first rotating shaft and store the converted energy. In some embodiments, the at least one energy output end is electrically connected to the at least one motor in order to deliver energy (e.g., electricity) to the at least one motor.

In some embodiments, the bottom panel, the first outer panel, the second outer panel, the left panel, the right panel, the first inner panel, and the second inner panel are integrally formed.

In some embodiments, the first gear and the third gear rotate in opposite directions; for example, if the third gear rotates counterclockwise, then the first gear will rotate clockwise. In some embodiments, the first gear and the second gear rotate in the same direction; for example, if the first gear rotates clockwise, then the second gear will rotate clockwise too.

### BRIEF DESCRIPTION OF THE SEVERAL VIEWS OF THE DRAWINGS

The present invention will be detailed below with reference to some illustrative embodiments in conjunction with the accompanying drawings, in which similar reference numerals indicate similar elements. It should be understood, however, that the embodiments disclosed herein are not intended to be restrictive of the scope of the invention.

FIG. 1 is a perspective view of the power transmission device according to an embodiment of the invention.

FIG. 2 is a top view of the power transmission device in FIG. 1.

FIG. 3 shows the relative positions of the first gear and the second gear in the invention.

FIG. 4 is a perspective view of the power transmission device according to another embodiment of the invention.

FIG. 5(a) and FIG. 5(b) show the power transmission device according to yet another embodiment of the invention, wherein the power transmission device includes more than one motor.

FIG. 6(a) and FIG. 6(b) show the power transmission device according to still another embodiment of the invention, wherein the power transmission device includes more than one motor and more than one gear train.

### DETAILED DESCRIPTION OF THE INVENTION

A detailed description of specific embodiments of the present invention is given below to demonstrate feasible modes of implementing the invention. A person skilled in the art would have no problem understanding the effects and advantages of the invention from the disclosure of the present specification. The invention may have other embodiments, i.e., be used and implemented in a different way from those disclosed herein. The details stated in the specification may be applied to meet a different need and may be modified or changed in various ways without departing from the spirit of the invention.

Hereinafter, the present invention is described with reference to some preferred embodiments and preferred aspects of the invention. The following description, however, serves only to expound the structure of the invention but not to limit the scope of the invention. The invention can be carried out in many ways other than those of the preferred embodiments.

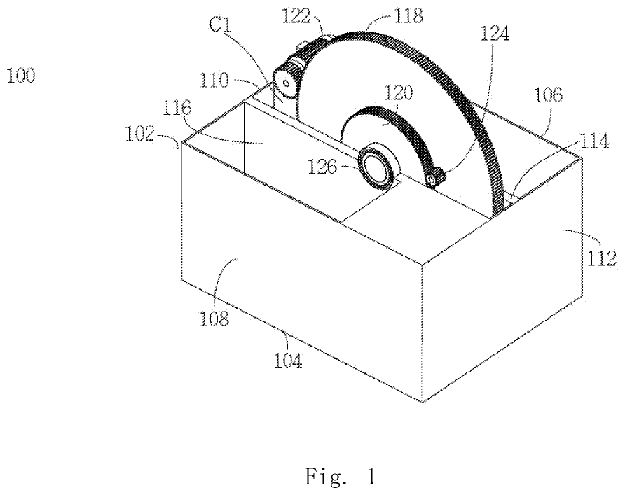

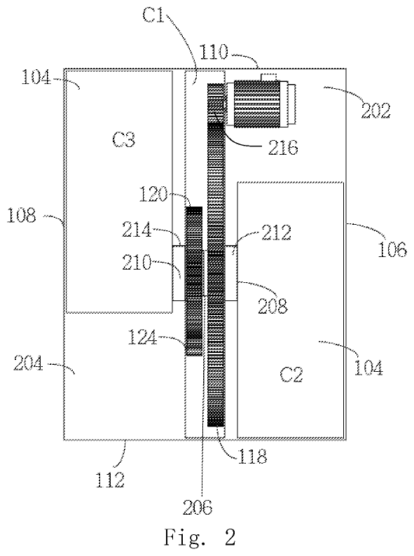

Referring to FIG. 1 and FIG. 2 for the power transmission device 100 according to an embodiment of the present invention, the power transmission device 100 includes a box 102, a first platform 202 (see FIG. 2), a second platform 204 (see FIG. 2), a rotating shaft 206 (see FIG. 2), a first gear 118, a second gear 120, a motor 122, and an energy output end 124. The box 102 has a bottom panel 104, a first outer panel 106, a second outer panel 108, a left panel 110, a right panel 112, a first inner panel 114, and a second inner panel 116. The first outer panel 106, the second outer panel 108, the left panel 110, the right panel 112, the first inner panel 114, and the second inner panel 116 are provided on the bottom panel 104. The bottom panel 104, the first inner panel 114, the second inner panel 116, the left panel 110, and the right panel 112 form a first chamber C1. The top end of the first inner panel 114 is provided with a first engaging groove 212 (see FIG. 2), and the top end of the second inner panel 116 is provided with a second engaging groove 126.

With continued reference to FIG. 2, which is a top view of the power transmission device 200, the first platform 202 is connected to the top edge of the first outer panel 106, the top edge of the left panel 110, and the top edge of the first inner panel 114; and the second platform 204 is connected to the top edge of the second outer panel 108, the top edge of the right panel 112, and the top edge of the second inner panel 116. A first bearing 208 and a second bearing 210 are mounted around the two ends of the rotating shaft 206 respectively and are fitted in the first engaging groove 212 and the second engaging groove 214 respectively. The first gear 118 is mounted around the rotating shaft 206, and so is the second gear 120. The first gear 118 and the second gear 120 are located between the first bearing 208 and the second bearing 210 such that when the rotating shaft 206 is placed in the first engaging groove 212 and the second engaging groove 214 via the first bearing 208 and the second bearing 210 respectively, a lower portion of the first gear and a lower portion of the second gear are in the first chamber C1. The motor 122 is provided on the first platform 202 and includes a third gear 216. The third gear 216 meshes directly with the first gear 118 such that when the motor 122 rotates the third gear 216, the first gear 118 is simultaneously rotated by the third gear 216 and in turn rotates the rotating shaft 206 and the second gear 120. The energy output end 124 is provided on the second platform 204 and functions as a stop. The energy output end 124 has a gear structure for meshing with the second gear and is configured to convert the energy generated by the rotation of the second gear 120 and store the converted energy.

In some embodiments, the first gear has a larger diameter than the second gear. More specifically, the diameter of the first gear in one embodiment is at least twice as large as the diameter of the second gear.

In another embodiment, the diameter of the first gear is 200 cm, and in order to drive the first gear, it is required that the motor in the invention have a rotation speed of at least 1600 revolutions per minute.

In one embodiment, referring back to FIG. 2, the bottom panel 104, the first outer panel 106, the first inner panel 114, the left panel 110, and the right panel 112 jointly form and surround a second chamber C2. In another embodiment, the bottom panel 104, the second outer panel 108, the second inner panel 116, the left panel 110, and the right panel 112 form a third chamber C3.

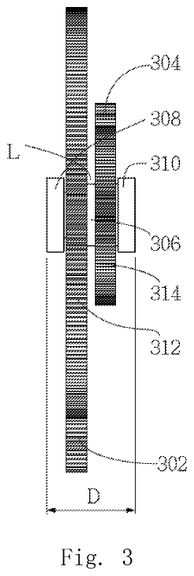

FIG. 3 shows the relative positions of the first gear 302 and the second gear 304 in the present invention. In one embodiment, the first gear 302 and the second gear 304 are spaced apart by a predetermined distance L. In some embodiments, the distance L is at least 4 cm. In one embodiment, the two ends of the rotating shaft 306 are mounted respectively with the first bearing 308 and the second bearing 310, and both the first gear 302 and the second gear 304 are mounted around the rotating shaft 306 and are located between the first bearing 308 and the second bearing 310. Some embodiments of the invention further include a first lining plate 312 and a second lining plate 314. The first lining plate 312 is mounted around the rotating shaft 306 and is located between the first gear 302 and the first bearing 308. The second lining plate 314 is also mounted around the rotating shaft 306 but is located between the second gear 304 and the second bearing 310. In one embodiment, the outer surface of the first bearing 308 and the outer surface of the second bearing 310 define a thick D therebetween.

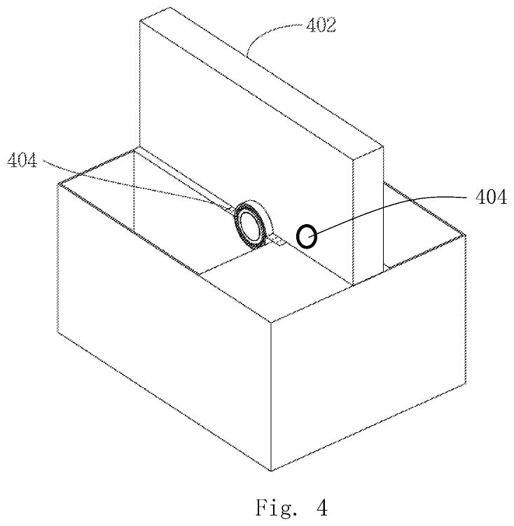

FIG. 4 shows the power transmission device according to another embodiment of the present invention. This power transmission device further includes a housing 402 for the sake of safety. The housing is mounted on the power transmission device such that an upper portion of the first gear and an upper portion of the second gear are located in the housing. The housing renders the first chamber into a closed structure, in which the first gear and the second gear can rotate continuously. In one embodiment, a bottom portion of the housing includes at least one locking hole 404, and a locking screw can be inserted through the locking hole 404 to secure the housing 402 to the first inner panel and the second inner panel. Some embodiments of the invention further include at least one output hole 406.

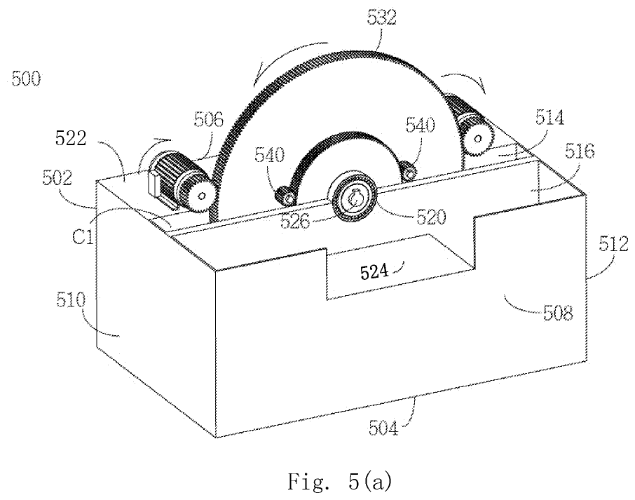

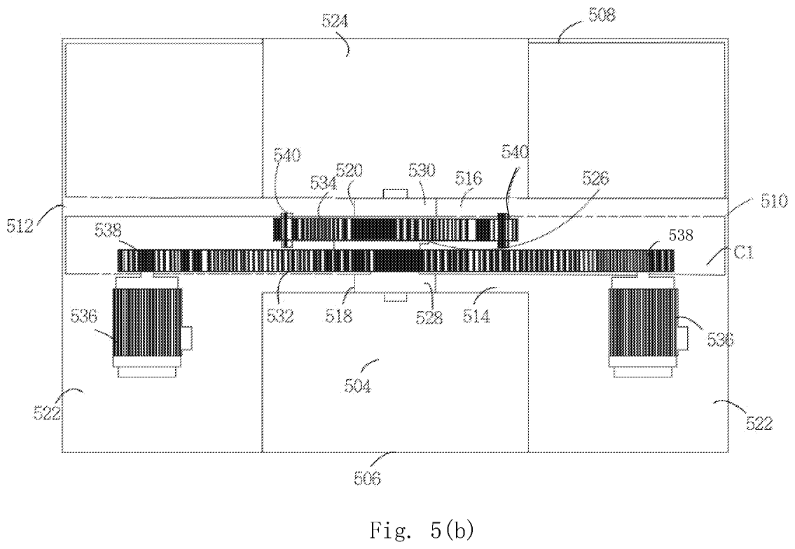

FIG. 5(a) and FIG. 5(b) show the power transmission device according to yet another embodiment of the present invention. This embodiment has a larger number of motors than the previous embodiments in order to increase the output energy effectively. The larger number of motors also result in a larger number of first platforms (where the motors are placed) than in the previous embodiments. It follows that the positions (or relative positions) of the first platforms in this embodiment are different from the position of the first platform in the previous embodiments. Moreover, the embodiment shown in FIG. 5(a) and FIG. 5(b) has a larger number of energy output ends (from which the energy output by the power transmission device can be drawn) than the previous embodiments. As shown in FIG. 5(a) and FIG. 5(b), the power transmission device 500 includes a box 502, a plurality of first platforms 522, a second platform 524, a rotating shaft 526 (see also FIG. 5(b)), a first gear 532, a second gear 534, at least one motor 536, and at least one energy output end 540. The box 502 has a bottom panel 504, a first outer panel 506, a second outer panel 508, a left panel 510, a right panel 512, a first inner panel 514, and a second inner panel 516. The first outer panel 506, the second outer panel 508, the left panel 510, the right panel 512, the first inner panel 514, and the second inner panel 516 are provided on the bottom panel 504. The bottom panel 504, the first inner panel 514, the second inner panel 516, the left panel 510, and the right panel 512 form a first chamber C1. The top end of the first inner panel 514 is provided with a first engaging groove 518 (see FIG. 5(b)), and the top end of the second inner panel 516 is provided with a second engaging groove 520. In one embodiment, the plural first platforms 522 are connected to the first outer panel 506 and the first inner panel 514, and the second platform 524 is connected to the second outer panel 508 and the second inner panel 516.

Referring to FIG. 5(b), which is a top view of the power transmission device 500, the two ends of the rotating shaft 526 of the power transmission device 500 are mounted with a first bearing 528 and a second bearing 530 respectively. The first bearing 528 and the second bearing 530 are fitted in the first engaging groove 518 and the second engaging groove 520 respectively. The first gear 532 is mounted around the rotating shaft 526, and so is the second gear 534. The first gear 532 and the second gear 534 are located between the first bearing 528 and the second bearing 530 such that when the rotating shaft 526 is placed in the first engaging groove 518 and the second engaging groove 520 via the first bearing 528 and the second bearing 530 respectively, a lower portion of the first gear 532 and a lower portion of the second gear 534 are in the first chamber C1. The motors 536 in this embodiment are provided on the first platforms 522 respectively and each include a third gear 538. The third gears 538 mesh directly with the first gear 532 such that when the motors 536 rotate their respective third gears 538, the first gear 532 is simultaneously rotated by the third gears 538 and in turn rotates the rotating shaft 526 and the second gear 534. The at least one energy output end 540 functions as a stop. More specifically, each energy output end 540 has a stop structure for contact with the periphery of the second gear 534 (which periphery may be viewed as the periphery of the rotating shaft 526) so as to draw energy from the rotating second gear 534. The energy output ends 540 are configured to convert the energy generated by the rotation of the second gear 534 and of the rotating shaft 526 and store the converted energy. In one embodiment, the energy output ends 540 are provided on the second platform 524.

In some embodiments, the device 500 further includes a first lining plate and a second lining plate. The first lining plate is mounted around the rotating shaft and is located between the first gear and the first bearing. The second lining plate is also mounted around the rotating shaft but is located between the second gear and the second bearing.

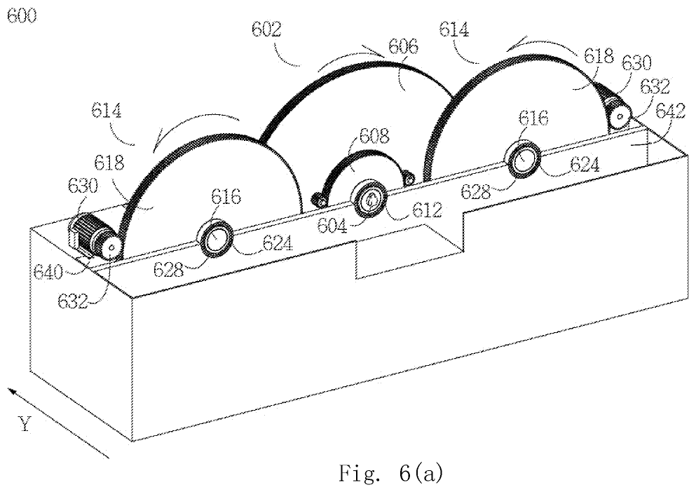

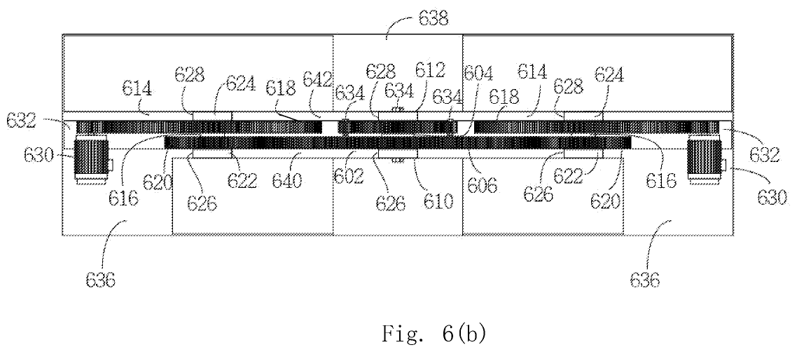

In order for the power transmission device of the present invention to output more energy, there may be an additional gear train besides an additional motor. For example, FIG. 6(a) and FIG. 6(b) show the power transmission device according to an embodiment that has more than one motor and more than one gear train. FIG. 6(a) and FIG. 6(b) also detail the relative positions of the gear trains in this power transmission device. As shown in the drawings, the power transmission device 600 has a primary gear train 602 that is composed of a rotating shaft 604, a first gear 606, a second gear 608, a first bearing 610, and a second bearing 612. To increase the energy input into and output from the primary gear train 602, the power transmission device 600 further has at least one secondary gear train 614 that includes a rotating shaft 616, a fourth gear 618, a fifth gear 620, a third bearing 622, and a fourth bearing 624, wherein the third bearing 622 and the fourth bearing 624 are mounted around the two ends of the rotating shaft 616 respectively and are fitted in a first engaging groove 626 and a second engaging groove 628 respectively. The mounting of the primary gear train 602 and of the at least one secondary gear train 614 is made possible by the plurality of first engaging grooves 626 provided at the top end of the first inner panel 640 and the plurality of second engaging grooves 628 provided at the top end of the second inner panel 642. In each secondary gear train 614 shown in the drawings, both the fourth gear 618 and the fifth gear 620 are mounted around the rotating shaft 616 and are located between the third bearing 622 and the fourth bearing 624, with a lower portion of the fourth gear 618 and a lower portion of the fifth gear 620 in the first chamber. In some embodiments, each fourth gear 618 has a larger diameter than the corresponding fifth gear 620.

Referring to FIG. 6(b), the motors 630 are provided on the first platforms 636 respectively. In one embodiment, the third gear 632 of each motor 630 of the power transmission device meshes directly with the corresponding fourth gear 618, and each fifth gear 620 meshes directly with the first gear 606. Therefore, when the motors 630 rotate their respective third gears 632, the fourth gears 618 are rotated respectively by the third gears 632 and in turn rotate the rotating shafts 616 and the fifth gears 620 in their respective secondary gear trains 614. As a result, the first gear 606 in the primary gear train 602 is rotated by the fifth gears 620 and in turn rotates the rotating shaft 604 and the second gear 608 in the primary gear train 602. In some embodiments, the at least one energy output end 634 functions as a stop, has a stop structure for contact with the periphery of the second gear 608 (which periphery may be viewed as the periphery of the rotating shaft 604) so as to draw energy from the rotating second gear 608, and is configured to convert the energy generated by the rotation of the second gear 608 and of the rotating shaft 604 and store the converted energy. In some embodiments, the at least one energy output end is electrically connected to the at least one motor in order to deliver energy (e.g., electricity) to the at least one motor. In one embodiment, the at least one energy output end is provided on the second platform 638.

In some embodiments, referring back to FIG. 6(a), when the motors 630 drive their respective third gears 632 into clockwise rotation (viewed from the second inner panel 642 toward the first inner panel 640, i.e., in the direction of the arrow Y in FIG. 6(a)), the fourth gears 618 are rotated counterclockwise and drive the rotating shafts 616 and the fifth gears 620 in their respective secondary gear trains 614 into counterclockwise rotation such that the first gear 606 in the primary gear train 602 is rotated clockwise by the fifth gears 620. In some embodiments, the first gear 606 is adjacent to the first inner panel 640 while the fourth gears 618 are adjacent to the second inner panel 642.

The present invention has been described above by way of some preferred embodiments of the invention. As a person skilled in the art would understand, the embodiments provided herein serve only to explain the invention but not to restrict the scope of the invention. The scope of the patent protection sought by the applicant is defined by, and encompasses equivalents of, the appended claims. A person skilled in the art may change or modify the disclosed embodiments without departing from the spirit or scope of the invention, and all such changes and modifications shall be viewed as equivalent changes or designs based on the spirit of the invention and therefore fall within the scope of the invention.

What is claimed is:

1. A power transmission device, comprising:
a box having a bottom panel, a first outer panel, a second outer panel, a left panel, a right panel, a first inner panel, and a second inner panel, wherein the first outer panel, the second outer panel, the left panel, the right panel, the first inner panel, and the second inner panel are provided on the bottom panel; the bottom panel, the first inner panel, the second inner panel, the left panel, and the right panel form a first chamber; the first inner panel has a top end provided with a first engaging groove; and the second inner panel has a top end provided with a second engaging groove;
a first platform connected to a top edge of the first outer panel, a top edge of the left panel, and a top edge of the first inner panel;
a second platform connected to a top edge of the second outer panel, a top edge of the right panel, and a top edge of the second inner panel;
a rotating shaft having two ends mounted respectively with a first bearing and a second bearing, wherein the first bearing and the second bearing are fitted in the first engaging groove and the second engaging groove respectively;
a first gear mounted around the rotating shaft;
a second gear mounted around the rotating shaft, wherein the first gear and the second gear are located between the first bearing and the second bearing, and a lower portion of the first gear and a lower portion of the second gear are located in the first chamber;
a motor provided on the first platform and comprising a third gear, wherein the third gear meshes directly with the first gear, and when the motor drives the third gear into rotation, the first gear is driven into rotation by the third gear and drives the rotating shaft and the second gear into rotation; and
an energy output end provided on the second platform, wherein the energy output end has a gear structure for meshing with the second gear.

2. The power transmission device of claim 1, wherein the first gear has a larger diameter than the second gear.

3. The power transmission device of claim 1, wherein the first gear has a diameter at least twice as large as a diameter of the second gear.

4. The power transmission device of claim 1, further comprising a first lining plate and a second lining plate, wherein the first lining plate is mounted around the rotating shaft and is located between the first gear and the first bearing, and the second lining plate is also mounted around the rotating shaft but is located between the second gear and the second bearing.

5. The power transmission device of claim 1, wherein the first gear and the second gear are spaced apart by a predetermined distance.

6. The power transmission device of claim 5, wherein the predetermined distance is at least 4 cm.

7. The power transmission device of claim 1, further comprising a housing mounted on the power transmission device such that the first chamber becomes a closed structure, with an upper portion of the first gear and an upper portion of the second gear located in the housing.

8. The power transmission device of claim 1, wherein the motor has a rotation speed of at least 1600 revolutions per minute.

9. The power transmission device of claim 1, wherein the bottom panel, the first outer panel, the first inner panel, the left panel, and the right panel form a second chamber.

10. The power transmission device of claim 1, wherein the bottom panel, the second outer panel, the second inner panel, the left panel, and the right panel form a third chamber.
